(19) United States
(12) Patent Application Publication
(10) Pub. No.: US 2011/0061661 A1
(43) Pub. Date: Mar. 17, 2011

(54) Purr pillow

(76) Inventor: Dana L. Hayes, Scottsdale, AZ (US)

(21) Appl. No.: 12/586,262

(22) Filed: Sep. 17, 2009

(51) Int. Cl. A61G 99/00

(52) U.S. Cl. 128/845

(57) ABSTRACT

Purr pillow with a microprocessor chip, a flat speaker, a power supply, an on off switch, a frequency selector switch, a random selection switch, a volume control, a standard amplifier circuit, a PC board and a housing. The microprocessor is programmed to produce purring sounds at frequencies ranging from 20 to 140 cycles per second, and the microprocessor, the speaker and additional the components are housed within the housing. A preferred embodiment includes the housing having a relatively low profile of approximately one quarter of an inch.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of portable audio devices and more specifically to a purr pillow.

The sound of a cat purring has been known to produce calming and healing effects on humans. A cat's purr is generally made up of deep base sounds usually ranging in frequency from between twenty five cycles per second to fifty cycles per second and sometimes extending up to one hundred and forty cycles per second. It has been scientifically shown that vibrations between twenty cycles per second and one hundred and forty cycles per second, when applied in dose proximity to a human patient, can provide therapeutic effects for improving bone growth, healing bone fractures, reduction of swelling, faster healing of wounds and increased mobility of muscle joints. It seems that these frequencies have an anabolic action that speeds recuperation of the above mentioned conditions. The Purr sound also has been shown to produce a calming effect in the form of reduced heart rate and lower blood pressure.

Devices for producing acoustic low range frequency sounds for the purposes of inducing sleep are known. For example Norman Raufiola, in his U.S. Pat. No. 3,384,074 discloses an acoustic sleep induction device that in placed within a stuffed toy which provides soothing to promote sleep, the acoustic stimuli being in the range of sixty to four hundred cycles per second. Christi Wilson in her U.S. Pat. No. 71,464,381 discloses an infant soothing seat where sound and motion generating devices are built into the cushion of a baby chair. Many other designs have been developed that include the insertion of a sound generating device into a pillow or stuffed animal toy.

However, there is a deficiency in the prior technology in that none of the prior art describes a pillow that includes a therapeutic cat purring sound. Additionally, no other device discloses a means to adjust the frequency of the purring sound, or to select a random frequency. Additionally, none of the prior art discusses the construction of a relatively low profile device that can be enclosed within a soft pillow so as not produce an uncomfortable bump in the pillow. Additionally, none of the prior art discloses the option of providing a remote control device that can be used to adjust the purr frequency as well as sound volume. Finally, none of the prior art describes a housing that includes flexible joints that allow the flat profile housing to more easily conform to the shape of a pillow.

### BRIEF SUMMARY OF THE INVENTION

The primary object of the invention is to provide a device that is associated with a pillow and includes a cat purr feature.

Another object of the invention is to provide a cat purr device that includes the ability to select from a plurality of purr frequency rates.

Another object of the invention is to provide a cat purr device that provides therapeutic benefits.

A further object of the invention is to provide a cat purr device emits digitally enhanced vibrations and sounds that imitate the rhythmic breathing pattern and the purring sound of a cat.

A further object of the invention is to provide a cat purr device that is housed in a low profile enclosure that will not cause an annoying bump in a pillow.

A further object of the invention is to provide a cat purr device whose housing includes flexible joints that allow it to bend and conform to normal pillow use.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed purr pillow comprising: a microprocessor chip, a flat speaker, a power supply, an on off switch, a frequency selector switch, a random selection switch, a volume control, a standard amplifier circuit, a PC board, a housing, said microprocessor programmed to produce purring sounds at frequencies ranging from 20 to 140 cycles per second, and said microprocessor, said speaker and additional said components housed within said housing.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a top plan view of the invention.

FIG. 2 is side section view of the invention.

FIG. 3 is a top view of the invention with top housing cover removed.

FIG. 4 is a side section view of a pillow containing the invention.

FIG. 5 is a bottom view of a pillow containing the invention.

FIG. 6 is a schematic view of the electronic portion of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

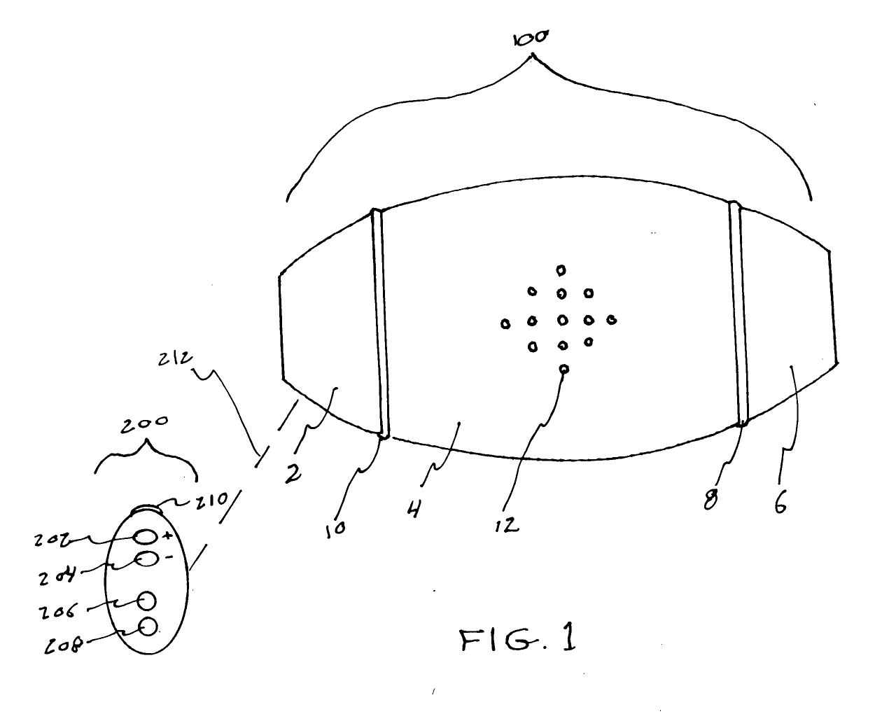

referring now to FIG. 1 we see a top plan view of the purr audio device 100 of the present invention as well as a plan view of remote control device 200 for the invention. The invention 100 is comprised of a housing that is divided into three sections 2, 4, 6. Each housing is molded of rigid material such as hi impact ABS, however, the sections are flexibly attached to each other by resilient strips 8, 10. In this way, the three sections 2, 4, 6 can flex and contour themselves to the possible curvature when installed within a pillow as will be described below. The housings 2, 4, 6 are hollow and are each made or rigid material such as molded ABS plastic. The central housing 4 includes a plurality of apertures 12 that let sound out from the speaker 18 enclosed within the housing 4. The remote control unit 200 includes switches 202, 204, 206, 208, 210 that allow the operator to adjust the sound coming from the speaker 18. Switch 210 turns the device 100 on and off. Switch 202 increases the volume. Switch 204 decreases the volume. Switch 206 selects from one of a plurality of purr frequency rates. Switch 208 selects a purr sound that continues at random frequencies within the ideal frequency rate. The purr frequencies range from twenty five cycles per second up to one hundred and forty cycles per second.

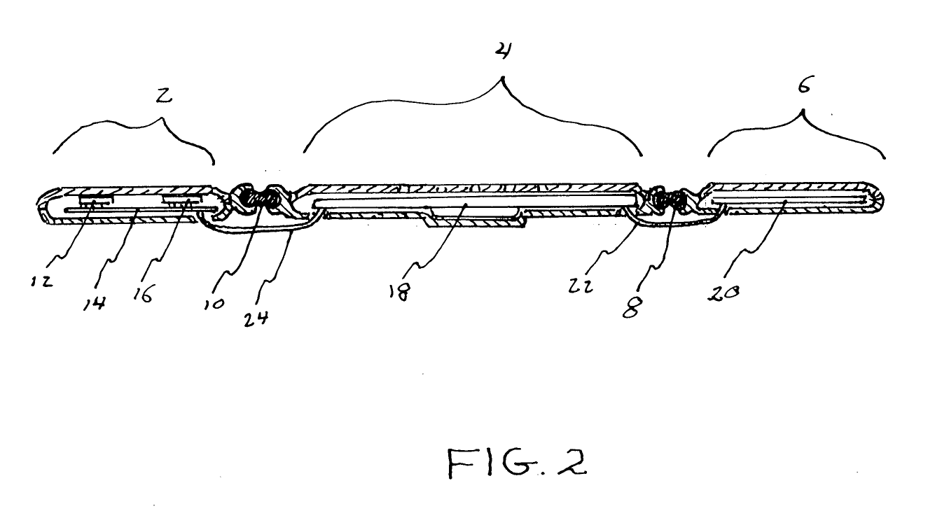

FIG. 2 shows a side section view of the invention 100. Housing 2 contains a printed circuit board 14 that holds a microprocessor 12 and standard transmitter 16 as well as other standard electronic components needed to generate a cat purring sound. The micro processor contains a digitally enhanced series of purr sounds that range in frequency from twenty five cycles per second to one hundred and forty cycles per second. This frequency range has been shown to be effective in speeding the healing process in humans as well as a means of stress reduction. Housing 4 contains a flat speaker such as the ones made by Askimo Portable Flat Panel Speaker System FPS-100W. These speakers put out a full sound at low frequencies and are approximately two hundred thousandths of an inch thick. Even though speaker 18 is thin in profile, its relatively large surface area produces a strong vibration which can be felt as well as heard by the user when lying on a pillow containing the device 100. Housing 6 containers a flat battery pack such as the Polaroid P100 Polapulse battery which is one hundred and eighty five thousandths of an inch thick. Therefore the entire thickness of all the housings 2, 4, 6 can be a bit more than a quarter of an inch thick. This thin profile allows the device 100 to fit in the bottom portion of a pillow as shown in section view 4 and not disturb the comfort of a person's head and neck while lying on the pillow in a standard way. Connector wires 22, 24 provide electrical contact to the battery power source 20, the speaker 18 and the components on PCB 14.

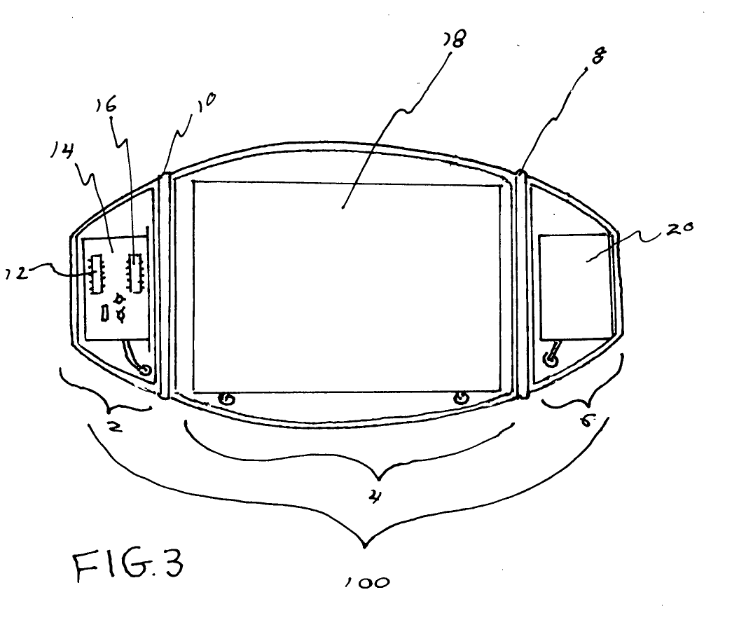

FIG. 3 shows a top view of the device 100 with the top cover of each housing 2, 4, 6 removed. Housing section 2 containers PCB 14 which holds microprocessor 12 and transmitter 16 and other standard components that create the digitized and amplified purr frequencies that are then sent to speaker 18 located in housing 4. Housing 6 containers flat battery 20 as described above. Resilient strips 8, allow housings 2 and 6 to flex as described above.

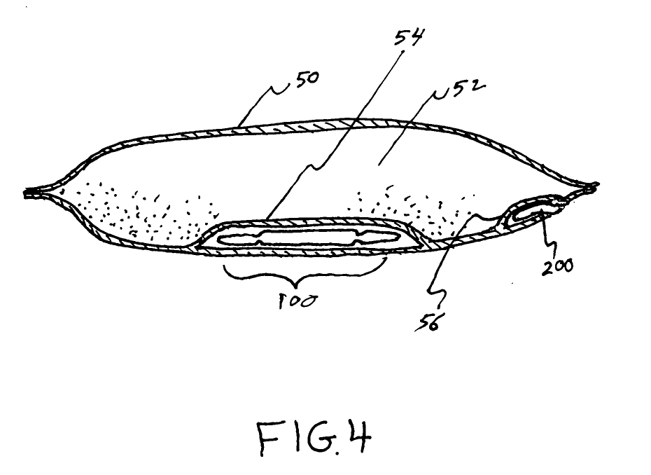

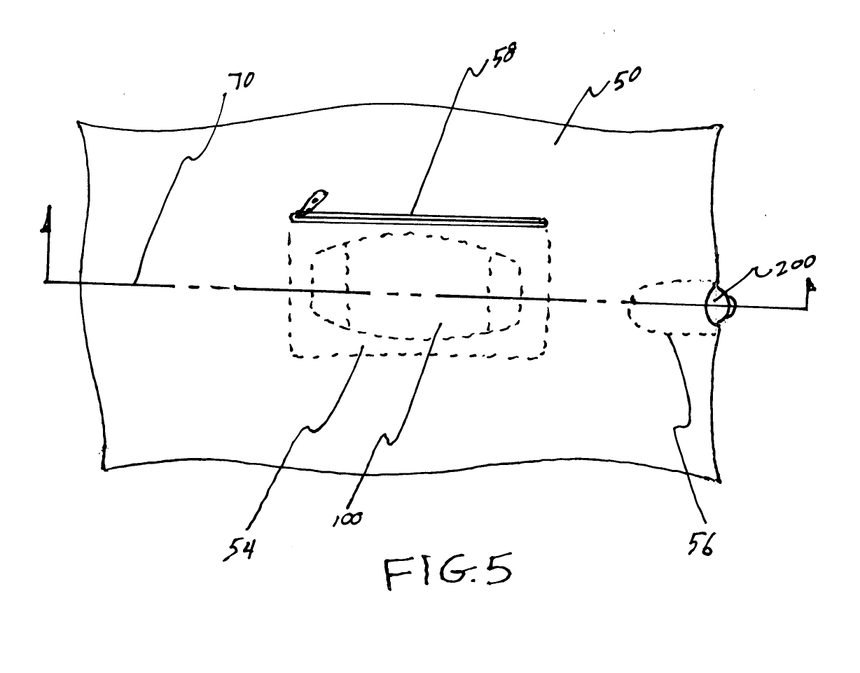

FIG. 4 shows a side section view of a pillow 50, as defined by section line 70 shown in FIG. 5, that includes a pocket 54 to house device 100. A second pocket 56 can slidably retain remote control unit 200. Obviously, an alternate embodiment of the invention could include the device 100 sold by itself and then simply placed under a standard pillow, however, the device 100 enclosed within the pillow is the preferred embodiment.

FIG. 5 shows a bottom view of pillow 50. Pocket 54 includes a zipper 58 or other standard closure to removably retain the device 100. Remote control unit 200 can slip in and out of pocket 56 via opening 60. The preferred embodiment includes a remote control unit, however it should be understood that the controls could also be placed on the device 100 itself. Access to the controls however, would be much easier with a remote control unit 200.

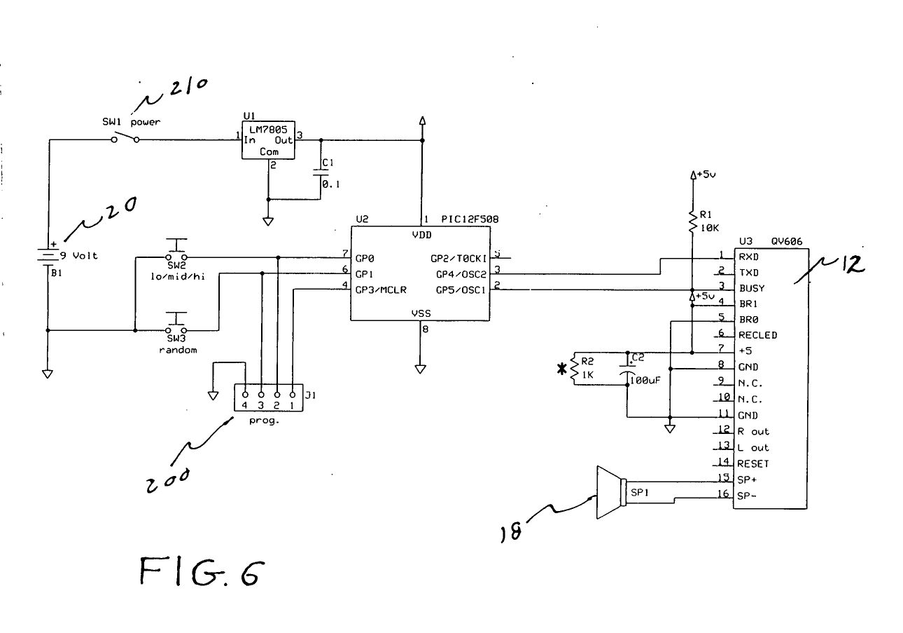

FIG. 6 show a schematic diagram of the electrical circuit of the device 100.

In the above described and illustrated way, the present invention provides a novel and therapeutic means to induce healing and relaxation in a user by the application of low frequency sounds in the form of a simulated cat purr.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. purr pillow comprising:
a microprocessor chip;
a flat speaker;
a power supply;
an on off switch;
a frequency selector switch;
a random selection switch;
a volume control;
a standard amplifier circuit;
a PC board;
a housing;
said microprocessor programmed to produce purring sounds at frequencies ranging from 20 to 140 cycles per second; and
said microprocessor, said speaker and additional said components housed within said housing.

2. Purr pillow as claimed in claim 1 further comprising said housing having a relatively low profile of approximately one quarter of an inch.

3. Purr pillow as claimed in claim 1 wherein said housing is comprised of a plurality of sub housings, said sub housings attached to each other by means of flexible joints.

4. Purr pillow as claimed in claim 1 further comprising a wireless remote controller for adjusting volume and purr frequency.

5. Purr pillow as claimed in claim 1 wherein said purr frequencies are therapeutic for bone growth/fracture healing, pain relief, swelling reduction, wound healing, muscle growth, tendon repair and improved mobility of joints.
